(19) United States
(12) Patent Application Publication
(10) Pub. No.: US 2018/0265396 A1
(43) Pub. Date: Sep. 20, 2018

(54) NOVEL COOLING SYSTEM FOR OPTICAL FIBER DRAWING

(71) Applicant: ZHONGTIAN TECHNOLOGY FIBRE OPTICS CO., LTD, Nantong (CN)

(72) Inventors: Zhicheng SUN, Nantong (CN); Zhizhong LIU, Nantong (CN); Shanshan CAO, Nantong (CN); Zhen WANG, Nantong (CN); Haitao ZHANG, Nantong (CN)

(73) Assignee: ZHONGTIAN TECHNOLOGY FIBRE OPTICS CO., LTD, Nantong (CN)

(21) Appl. No.: 15/756,581

(22) PCT Filed: Dec. 29, 2015
(86) PCT No.: PCT/CN2015/099437

§ 371 Date: Feb. 28, 2018

(30) Foreign Application Priority Data
Aug. 31, 2015 (CN) 201510542005.1

(51) Int. Cl. C03B 37/027

(52) U.S. Cl. CPC C03B 37/02718; C03B 2205/55

(57) ABSTRACT

A cooling system for optical fiber drawing is used for decreasing the temperature of an optical fiber before coating, avoiding the occurrence of bubbles in a coating, ensuring a stable coating state of the optical fiber, and reducing the amount of helium gas used, being suitable for high-speed drawing. The cooling system consists of shutters of the cooling pipe; a helium gas guiding device, a cooling pipe body, a cooling water circulation and cooling device, a coating diameter control system, a cooling water pipe and a gas pipe. Several single-section cooling pipes are connected to each other by the gas intake connection devices. The outer wall of each segment of the cooling pipes is covered with a polystyrene foam thermal insulating layer, and the helium gas guiding device guides the gas within the pipe at a suitable guiding flow rate to achieve the optimal cooling effect.

### CROSS REFERENCE TO RELATED APPLICATIONS

This application is the national phase entry of International Application No. PCT/CN2015/099437, filed on Dec. 29, 2015, which is based upon and claims priority to Chinese Application No.201510542005.1, filed on Aug. 31, 2015, the entire contents of which are incorporated herein by reference.

### TECHNICAL FILED

The present invention relates to the field of optical fiber drawing and manufacturing, which is used for cooling the optical fiber in high-speed drawing production, so that the optical fiber enters the coating system at a suitable temperature, ensuring the optical fiber coating quality.

### BACKGROUND

During the high-speed drawing production, the baking temperature of the optical fiber is at about 2000 degrees. Directly entering the coating process with such a high temperature will lead to abnormal coating, thus, interrupting the production. For handling this, the cooling pipe needs to be used for forced cooling of the optical fiber. Chinese patent CN1450009A describes an optical fiber cooling pipe proposed by the applicant Alcatel. The cooling pipe is composed of a lumen and a set of suction pipe and intake pipe. Gas injection and pumping can be used to improve the cooling effect, but it is difficult for processing and hard to clean when producing. When the ordinary cooling pipe is used, large amount of helium gas will be consumed, and the cooling is uneven, high-speed drawing is prone to the problem of large diameter fluctuation of the coating. Besides, the air holes in ordinary tubular cooling pipe are difficult to clean and the cavity of the cooling pipe not only absorbs the internal heat, but also absorbs the heat from the surroundings, thus affecting the cooling effect and optical fiber strength.

### SUMMARY OF THE INVENTION

The technical problem to be solved by the present invention is to improve the cooling effect of the existing cooling pipe. On the basis of the current cooling pipe, the present invention provides a novel cooling system for optical fiber drawing, further reducing consumption of the helium gas, stabilizing the coating diameter of the optical fiber and ensuring the strength of the optical fiber.

In order to solve the above technical problem, the technical solution of the present invention is shown as below:

A novel cooling system for optical fiber drawing, the invention point is as follows: the novel cooling system for optical fiber drawing includes upper and lower shutters of a cooling pipe, a helium gas drainage plug, a cooling pipe body, a cooling water circulation and cooling device, a coating diameter meter, coating diameter control system, cooling water pipes and gas pipes.

The upper of the lower shutter of the cooling pipe is installed with the helium gas drainage plug, the upper end of the helium gas drainage plug is connected to the cooling pipe body; and a coating device, a curing device and a coating diameter meter are provided below the cooling pipe body. The helium gas drainage plug is connected to the first mass flow meter and the drainage pump through the gas pipe in sequence.

The cooling pipe body includes a single-section cooling pipe and a helium gas intake device, the cooling pipe body is composed of three to six of the single-section cooling pipes, the single-section cooling pipes are connected to each other from end to end by means of the helium gas intake device. The upper end and lower end of the single-section cooling pipe respectively has a water hole, two adjacent water holes between the single-section cooling pipes are connected through the cooling water pipe. The water holes at the uppermost end and the lowermost end of the cooling pipe body are connected through the cooling water pipe, and the cooling water circulation and cooling device is connected in series, the helium gas intake device is connected to the second mass flow meter and the helium gas.

The coating diameter meter is connected to the coating diameter control system, and the coating diameter control system is connected to the first mass flow meter and the second mass flow meter.

Further, the cooling water circulation and cooling device is composed of a cooling water tank, a water pump and a refrigeration unit.

Further, the length of the single-section cooling pipe is 2 m, lumen diameter of the single-section cooling pipe is 20-30 mm, the outer wall of the single-section cooling pipes is covered with a polystyrene foam thermal insulating layer, the upper end and the lower end of the single-section cooling pipe body are provided with threads.

Further, the helium gas intake device is composed of an upper ring and a lower ring, threads are provided on the inner and outer walls of the upper ring, the lower ring is provided with an internal thread, and the internal thread of the upper ring is connected with the single-section cooling pipe of the upper segment, the external thread of the upper ring cooperates with the internal thread of the lower ring, and four gas inlets are provided around the middle of the lower ring. The air inlet hole communicates with the lumen at an elevation angle of 45° , helium gas is blown into the interior of the cooling pipe body through the gas inlet, and the lower ring is connected to a cooling pipe in lower segment through threads.

### THE ADVANTAGES OF THE PRESENT INVENTION ARE SHOWN AS BELOW

1) The present invention has the characteristics of easy cleaning, good cooling effect, high optical fiber coating quality, stable coating diameter and less consumption of helium gas.

2) In the present invention, the optical fiber is cooled by the helium gas at a certain angle opposite to the optical fiber movement direction by a unique helium gas intake device, to disturb the boundary layer gas and improve the cooling effect.

3) The outer wall of the cooling pipe is covered with a polystyrene foam thermal insulating layer to reduce the heat exchange between the cooling pipe and the outside air and improve the heat exchange effect between the cooling pipe and the gas in the pipe.

4) Under the control of the coating diameter control system, the helium gas drainage device can improve the cooling effect by leading the air flow in the pipe under the cooling pipe body with a certain drainage flow rate, thereby reducing the helium gas consumption.

5) The flow rate of drainage and the injection rate of helium gas are controlled by the coating diameter control system. When the diameter value detected by the coating diameter meter is fed back to the system, the system compares the detected value with the standard control value and adjusts the drainage speed and helium gas inlet flow rate, so that coating diameter can be maintained stable during production process.

6) The helium gas intake device not only has the function of gas intake, that is, the helium gas is blown into the cooling pipe through this component, but is also the connecting piece of each single-section cooling pipe. In the helium gas intake device, two cylindrical rings are screwed together through the threads, both inside and outside of the internal cylindrical ring are provided with threads. The helium gas intake device is connected to the upper and lower cooling pipes through the threads. In addition, gas inlets are arranged around the middle of the lower ring of the helium gas intake device, each inlet communicates with the lumen at 45° elevation angle. The helium gas is blown into the cooling pipe through the gas inlet. The component can be removed when not in production, which is easy to clean and avoid residues affecting optical fiber strength. The helium gas intake device can be unlocked in the initial lifting stage of drawing to check the position of the optical fiber in the cooling pipe. By adjusting the position of the cooling pipe, the situations that drawing production and optical fiber strength affected by the poor cooling pipe alignment can be avoided, at the same time, the optical fiber is kept in a better cooling state.

### BRIEF DESCRIPTION OF THE DRAWINGS

FIG. 1 is a structural schematic diagram of the system of the present invention.

FIG. 2 is a structural schematic diagram of a helium gas intake device according to the present invention.

### DETAILED DESCRIPTION OF THE INVENTION

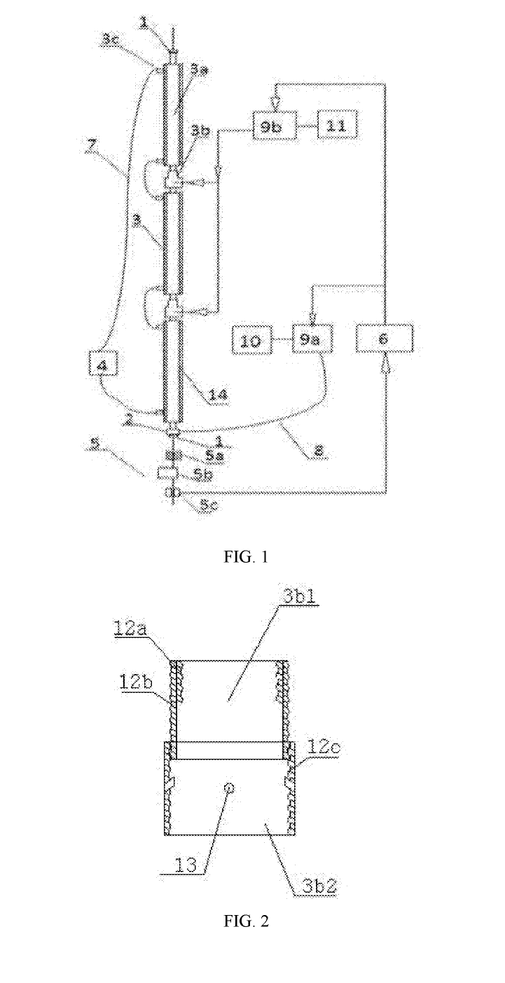

A novel cooling system for optical fiber drawing is shown in FIG. 1. The novel cooling system for optical fiber drawing includes upper and lower shutters 1 of the cooling pipe, drainage plug 2, cooling pipe body 3, cooling water circulation and cooling device 4, coating and curing device 5, coating diameter control system 6, water pipe 7 and gas pipe 8; the upper end of lower shutter 1 of the cooling pipe is mounted with helium gas drainage plug 2, the upper end of helium gas drainage plug 2 is connected to cooling pipe body 3. Coating and curing device 5 is provided below the cooling pipe. Helium gas drainage plug 2 is sequentially connected to first mass flow meter 9a and drainage pump 10 through gas pipe 8. Cooling pipe body 3 includes single-section cooling pipe 3a and helium gas intake device 3b. Cooling pipe body 3 is composed of three to six of single-section cooling pipes 3a, single-section cooling pipes 3a are connected end to end by helium gas intake device 3b, the upper and lower ends of one side of single-section cooling pipe 3a are respectively provided with water hole 3c. The two adjacent water holes 3c between each of single-section cooling pipes 3a are connected by cooling water pipe 7, water holes 3c of the uppermost end and the lowermost end of cooling pipe body 3 are connected to each other by water pipe 7, and cooling water circulation and cooling device 4 is connected in series. Helium gas intake device 3b is connected to second mass flow meter 9b and helium gas 11, wherein the outer wall of the single-section cooling pipe is coated with polystyrene foam thermal insulating layer 14. The coating diameter meter in coating and curing device 5 is connected to coating diameter control system 6, and coating diameter control system 6 is connected to first mass flow meter 9a and second mass flow meter 9b. Coating and curing device 5 includes coating device 5a, curing device 5b, and coating diameter meter 5c. Cooling pipe body 3 is followed sequentially by coating device 5a, curing device 5b and coating diameter meter 5c. Coating diameter meter 5c is connected to coating diameter control system 6.

Helium gas intake device 3b as shown in FIG. 2, includes upper ring 3b1 and lower ring 3b2. The inner and outer walls of upper ring 3b1 are provided with threads 12a and 12b. Lower ring 3b2 is provided with internal thread 12c. Upper ring 3b1 is connected to the upper single-section cooling pipe 3a through internal thread 12a, upper ring 3b1 corporates with internal thread 12c of lower ring 3b2 via the external thread 12b, lower ring 3b2 is connected to the lower single-section cooling pipe via the thread 12c, the middle of lower ring 3b2 is provided with four gas inlets 13, gas inlets 13 at an elevation angle of 45° communicates with the lumen, helium gas is blown into cooling pipe body 3 through the gas inlets 13.

The optical fiber sequentially passes through upper shutter 1 of the cooling pipe, cooling pipe body 3, helium gas drainage plug 2, lower shutter 1 of the cooling pipe, and coating and curing device 5. Cooling water circulation and cooling device 4 injects cold water into cooling pipe body 3, and draws back the warm water. Coating diameter control system 6 controls second mass flow meter 9b to inject helium gas 11 into helium gas intake device 3b. At the same time, coating diameter control system 6 controls first mass flow meter 9a to adjust the flow rate of the drainage and to pull the gas in the pipe.

The basic principles and main features of the present invention, as well as the advantages of the present invention, are shown and described above. It should be understood by those skilled in the art that the present invention is not limited to the above embodiments, and the above embodiments and description only illustrate the principle of the present invention. Without departing from the spirit and scope of the present invention, the present invention also has various modifications and improvements which fall within the scope of the claimed invention. The scope of protection demanded by the present invention is defined by the appended claims and their equivalents.

What is claimed is:

1. A novel cooling system for optical fiber drawing, comprising:
a cooling pipe shutter, a helium gas drainage device, a cooling pipe body, a cooling water circulation and cooling device, a coating diameter meter, a coating diameter control system, a cooling water pipe and a gas pipe; wherein
an upper end of a lower shutter of a cooling pipe is installed with a helium gas drainage plug, an upper of the helium gas drainage plug is connected to the cooling pipe body, and a coating and curing device are provided below the cooling pipe, the helium gas drainage plug is connected to a first mass flow meter and a drainage pump through the gas pipe in sequence;
the cooling pipe body comprises a single-section cooling pipe and a helium gas intake device, the cooling pipe body is composed of three to six of the single-section cooling pipes, the single-section cooling pipes are connected to each other end to end through the helium gas intake device, an upper end and a lower end of the single-section cooling pipe are provided respectively with a water hole, two adjacent water holes between the single-section cooling pipes are connected through the cooling water pipe, water holes at an uppermost end and a lowermost end of the cooling pipe body are connected through the cooling water pipe, and the cooling water circulation and cooling device is connected in series, the helium gas intake device is connected to a second mass flow meter and helium gas;
the coating diameter meter is connected to the coating diameter control system, and the coating diameter control system is connected to the first mass flow meter and the second mass flow meter.

2. The novel cooling system for optical fiber drawing according to claim 1, wherein the cooling water circulating and cooling device consists of a cooling water tank, a water pump and a refrigeration unit.

3. The novel cooling system for optical fiber drawing according to claim 1, wherein a length of the single-section cooling pipe is 2 m, a lumen diameter of the single-section cooling pipe is 20-30 mm, an outer wall of the single-section cooling pipe is covered with a polystyrene foam thermal insulating layer, an upper end and a lower end of a single-section cooling pipe body are provided with a plurality of threads.

4. The novel cooling system for optical fiber drawing according to claim 1, wherein the helium gas intake device is composed of an upper ring and a lower ring, a plurality of threads are provided on an inner wall and an outer wall of the upper ring, the lower ring is provided with an internal thread, and an internal thread of the upper ring is connected with the single-section cooling pipe of an upper segment, an external thread of the upper ring cooperates with the internal thread of the lower ring, and four gas inlets are provided around a middle part of the lower ring, the gas inlets communicate with a lumen at an elevation angle of 45° , the helium gas is blown into an interior of the cooling pipe body through the gas inlet.

5. The novel cooling system for optical fiber drawing according to claim 1, wherein a lower end of the cooling pipe body is followed sequentially by a coating device, a curing oven and the coating diameter meter, the coating diameter meter is connected to the coating diameter control system.

6. The novel cooling system for optical fiber drawing according to claim 1, wherein the helium gas drainage device is composed of the helium drainage plug, the gas pipe, the first mass flow meter and the drainage pump, and the first mass flow meter is connected to the coating diameter control system.
